(19) United States
(12) Patent Application Publication
(10) Pub. No.: US 2010/0063708 A1
(43) Pub. Date: Mar. 11, 2010

(54) Diesel cycle internal combustion engine

(76) Inventors: Alois Dotzer, Allersberg (DE); Georg Gruber, Hilpoltstein (DE); Thomas Kaiser, Munchen (DE)

Correspondence Address: ROBERT A. SABOURIN, 17 LINDOR ROAD, NORTH READING, MA, 01864, US

(21) Appl. No.: 12/397,445

(22) Filed: Mar. 4, 2009

(30) Foreign Application Priority Data
Mar. 7, 2008 (DE) 102008013163

(51) Int. Cl. F02D 43/00; G01N 25/18; G01N 11/00

(52) U.S. Cl. 701/102; 73/25.03; 73/54.01

(57) ABSTRACT

The invention proceeds from a diesel cycle internal combustion engine that can be operated with a fuel having a low ignition point and a fuel having a higher ignition point, with at least one fuel tank (1), with a fuel pump (7), with a high-pressure pump (11), with an injection system (12) and with an electronic controller (17) in which different control parameters for operation with the fuel having the low ignition point and for operation with the fuel having the higher ignition point are stored. According to the invention, control parameters (19, 20) for the start of injection are stored in the electronic controller (17), wherein the start of injection for the fuel having the higher ignition point is retarded relative to the start of injection for the fuel having the low ignition point exclusively in the high-load range or exclusively in the medium-load and high-load ranges.

The invention relates to a diesel cycle internal combustion engine according to the preamble of claim 1.

Because of the increasing scarcity of petroleum, and for reasons of environmental protection, engines have been introduced that can be operated with vegetable oil. To date, precombustion and swirl-chamber diesel engines in particular have been altered to be suitable for operation with vegetable oil on what is called the single-tank system. However, these engines cannot continue to be operated with diesel fuel after adaptation to vegetable oil.

In the new direct-injection diesel engines, which operate using the pump/nozzle or common rail technology, the parameters for the engine controller are optimized for a single fuel such that operation with an alternative fuel is no longer possible in practice. This can be traced back to the very different properties of vegetable oil and diesel fuel. For example, while diesel fuel exhibits no change in viscosity over a considerable temperature range, vegetable oil is very viscous at lower temperatures. Moreover, vegetable oil is a fuel whose ignition point is considerably higher than that of diesel fuel. This means that for vegetable oil, the temperature to which the vegetable oil must be heated so that it self-ignites in the presence of oxygen without an ignition source, solely on account of its heating, is significantly higher than is the case for diesel fuel. The ignition point of diesel fuel is approximately 220° C., while the ignition point of vegetable oil—depending on the type—is approximately 300° C.

These differences have the result that for modern engines which have been optimized for performance and exhaust, the use of these different fuels also makes it necessary to operate with different engine control parameters. This would mean that an engine that has once been adapted for operation with vegetable oil can no longer be operated with diesel fuel. Since a comprehensive supply of vegetable oil is not ensured across Europe, this would entail an enormous inconvenience. The further market penetration of vegetable oil engines would thus be seriously jeopardized.

Similar problems arise with the so-called two-tank systems. These engines are operated with diesel fuel during starting and in the lower speed range. They are switched over to vegetable oil in the higher speed range. In this case, too, the engine would have to be operated with different control parameters in diesel operation than in vegetable oil operation. This is especially true if the demanding new emission standards are to be met in operation with both fuels.

The object of the invention is to adapt a diesel cycle internal combustion engine such that it can be operated with both vegetable oil and diesel fuel, delivering comparable performance and exhibiting comparable exhaust gas characteristics with both fuels.

The object is attained by a diesel cycle internal combustion engine with the features of claim 1. It has been determined that the start of injection is of primary importance for the behavior of the internal combustion engine when using different fuels. Surprisingly, at high speeds in the high-load range (or in the medium-load and high-load ranges), the start of injection for vegetable oil, with its high ignition point, does not have to be advanced, but instead must be retarded relative to diesel fuel with its significantly lower ignition point. This discovery runs counter to all previous thinking concerning the differences between diesel fuel and vegetable oil. As a result of the inventive displacement of the start of injection when operating with vegetable oil, superior combustion is achieved despite the higher ignition point of vegetable oil relative to diesel fuel.

Advantageously, the end of injection is retarded as well. In this way, the same injection time period results for vegetable oil and diesel fuel, with the injection period for vegetable oil merely being retarded relative to diesel fuel.

In an advantageous manner, precisely the opposite of what occurs in the high-load range takes place in the low-load range is. Here, the start of injection with vegetable oil is advanced as compared to diesel oil. This measure, too, ensures clean burning of vegetable oil.

In an advantageous example embodiment, the fuel being used at the present time is detected with the aid of a sensor, and the control parameters are automatically adjusted as a function of the detected fuel. An additional improvement in convenience can be achieved by this means, since a manual switchover is unnecessary. Moreover, this measure prevents switchover of the control parameters from being forgotten and keeps the engine from being operated with control parameters that are not optimized for this fuel type.

Preferably, a thermal conductivity sensor whose electrical resistance changes according to changes in temperature is used as the sensor. The temperature change of the sensor results from the different thermal conductivities of the different fuel types. The change in resistance is sensed and is associated with the corresponding fuel type by the microprocessor.

In another example embodiment, the fuel type used is determined through the different viscosity as a function of temperature. Since the viscosity of vegetable oil is temperature-dependent, it is useful to determine not only the viscosity itself, but also the temperature of the fuel. Only at high temperatures is the viscosity of vegetable oil comparable to the viscosity of diesel fuel; in contrast, at lower temperatures vegetable oil is significantly more viscous than diesel fuel.

The viscosity can best be determined through pressure ratios. Thus, for example, a restrictor can be used, with a pressure sensor being provided both before and after the restrictor. The viscosity of the fuel can be determined through the difference in the measured pressures.

With the alternating use of different fuels, it can generally be assumed in a single-tank system that a mixture of the two fuel types is present in the fuel tank. The properties of this fuel mixture are now dependent on the mixing ratio of the two fuel types. Thus, in an advantageous manner a threshold for the sensed properties is determined at which, in each case, switchover to the other control parameters takes place. For a viscosity measurement, it is in turn necessary to take into account here that the viscosity of vegetable oil is strongly temperature-dependent. Consequently, a temperature measurement must always be performed at the same time and placed in relationship with the measured viscosity.

When vegetable oil with a high ignition point is used as a fuel, it has now been determined that even a relatively small admixture of diesel fuel, with a low ignition point, affects the properties of this fuel mixture such that it resembles the properties of pure diesel fuel considerably more than the properties of pure vegetable oil. The mixing ratio at which the properties of the fuel mixture approach those of pure diesel fuel is at a composition of 75 to 95 percent vegetable oil and 5 to 25 percent diesel fuel, depending on the vegetable oil used.

Ideally, the threshold value for the detected properties of the fuel mixture is set such that the control parameters are switched to operation with vegetable oil when the mixture contains less than 20% diesel fuel, and conversely, switchover to the control parameters for diesel fuel takes place when the mixture contains more than 20% diesel fuel. Since a fuel into which 80% pure rapeseed oil has been mixed normally exhibits the combustion properties of pure vegetable oil, this means that all fuel mixtures that contain more than 80% vegetable oil are driven using the control parameters for vegetable oil, while all mixtures with more than 20% diesel fuel are driven using the control parameters for diesel fuel.

In modern engines, the electronic controller generally contains a microprocessor that accesses a data memory in which the control parameters are stored. By means of the inventive change in the start of injection as a function of the fuel used and the storage of these different control parameters, the engine controller can now be optimized for both fuel types. This also makes it possible to use the different fuel types in alternation as a function of availability.

For standard production internal combustion engines that are originally designed for use only with one fuel type, a second electronic controller can be provided. In this case, the sensor for identifying the fuel type used is connected to an electronic changeover switch that evaluates the sensor signals and switches to the first or second electronic controller as a function of this evaluation.

However, a different concept appears more advantageous. Here, different sets of control parameters are to be accessed by only one electronic controller. Thus, the electronic controller obtains the different control parameters for the different fuels from different data memories, for example. Naturally, more than two data memories can also be used here, so that not just one, but several threshold values can be established.

When only a single electronic controller is used, continuous adaptation to different mixing ratios of the fuel types used is also possible. Here, an algorithm must be stored into which the different mixing ratios are input and out of which the appropriate control parameters for the start of injection are then derived.

Further details and advantages of the invention are evident from the dependent claims in conjunction with the description of an exemplary embodiment, which is explained in detail with reference to the drawings.

The drawings show:

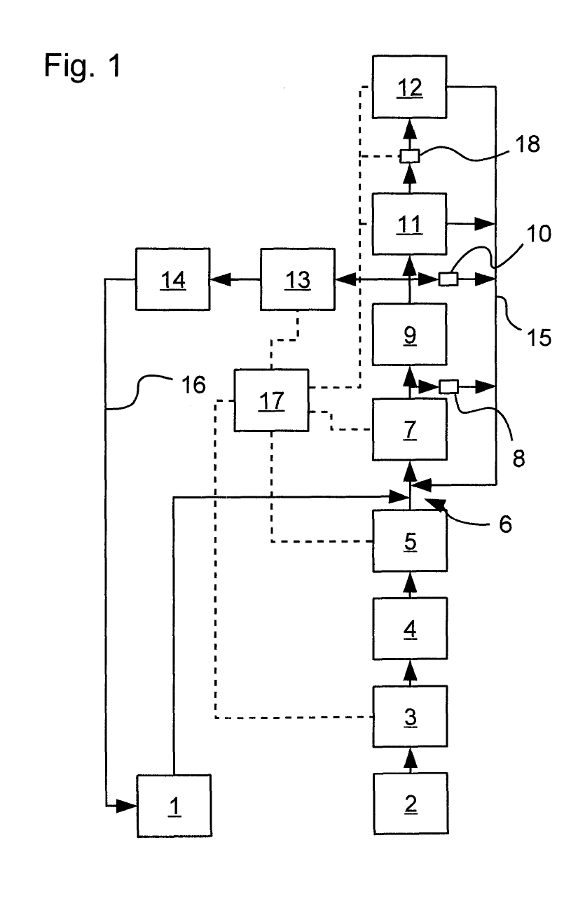

FIG. 1 a block diagram of an inventive internal combustion engine,

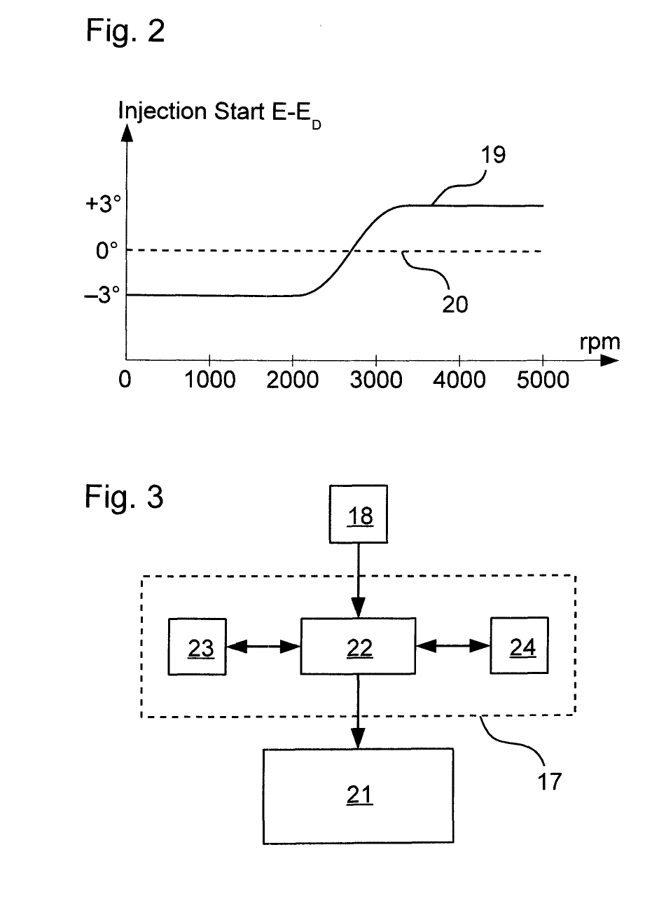

FIG. 2 a diagram of the start of injection, and

FIG. 3 a block diagram of the electronic controller.

The fuel circuit shown in FIG. 1 is what is called a two-tank system. A large vegetable oil tank 1 and a small diesel tank 2 are provided. The two fuels are mixed with one another at the fuel combiner 6. A diesel fuel pump 3, a first restrictor 4 and a first solenoid valve 5 are also located between the diesel fuel tank 2 and the fuel combiner 6.

The fuel is made available to the high-pressure pump 11 via the fuel pump 7 and the filter 9. There, the fuel is pressurized to over 1,000 bar, and arrives in this way at the injection system 12. This injection system 12 can be designed using common-rail technology, so that the pressurized fuel is first delivered to a pressure reservoir not shown here. The fuel from this pressure reservoir is injected as needed into the combustion chamber through injectors that are likewise not specifically shown.

Between the fuel filter 9 and the high-pressure pump 11, a return line 16 branches off into the vegetable oil tank 1, into which only pure vegetable oil from the vegetable oil tank 1 is to be returned. A second solenoid valve 13 and a second restrictor 14 are provided in the return line 16.

A fuel return 15 terminates between the first solenoid valve 5 and the fuel pump 7. Fuel returned through this line is immediately made available again to the fuel pump 7. Leakage fuel from the injection system 12 and the high-pressure pump 11 is introduced into the fuel return 15. In addition, the fuel return 15 is fed through a first pressure relief valve 8 and a second pressure relief valve 10.

An electronic controller 17 is provided, and is connected through lines, represented in the drawing as dashed lines, to some of the components shown. Of particular note here is the connection to the injection system 12, by which means the start of injection is controlled.

FIG. 3 shows the structure of the electronic controller 17 in greater detail. The electronic controller 17 has a microprocessor 22, a first data memory 23, and a second data memory 24. The control parameters for operation with vegetable oil are stored in the first data memory 23, whereas the control parameters for operation with diesel fuel are stored in the second data memory 24. Depending on the fuel used, the microprocessor 22 accesses either the data from the first data memory 23 or from the second data memory 24.

The microprocessor 22 obtains the data from which it is possible to determine which fuel is being used from the sensor unit 18. In a manner not shown here in detail, the sensor unit 18 can consist of two pressure sensors, one before and one after a restrictor in the fuel combiner, together with a temperature sensor. By contrast, in the fuel feed described in FIG. 1, the sensor unit 18 has only a flow sensor. Since the quantity of diesel fuel delivered is always known, the ratio of diesel fuel to vegetable oil can be determined in a simple manner from the quantity flowing through the sensor unit 18.

In both sensor units that are mentioned by way of example, the microprocessor 22 determines the composition of the fuel present in the feed based on the signals from the sensor unit 18. If the proportion of vegetable oil in the fuel mixture is greater than 80%, the microprocessor 22 takes the control parameters from the first data memory 23 and controls the engine 21 therewith. At a threshold that is to be associated with a mixing ratio of 80% vegetable oil and 20% diesel fuel, the microprocessor 22 switches to the second data memory 24, and as a result controls the engine 21 with control parameters from the second data memory 24 in the case of a diesel content of greater than 20% in the fuel mixture. Here, the engine 21 is referenced as representing all components with which the controller 17 communicates electrically through the connections shown as dashes.

At a startup of the internal combustion engine, the diesel fuel pump 3 is also placed in operation. The delivery volume of the diesel fuel pump 3 is dimensioned such that a slight overpressure is always present at the first restrictor 4. Moreover, the diesel fuel pump 3 and first restrictor 4 are matched such that the quantity of diesel fuel delivered from the diesel fuel tank 2 is adequate for operation of the internal combustion engine at idle speed. In this way, the injection system 12 receives pure diesel fuel. In this operating condition, the second solenoid valve 13 is closed, so that no return flow to the vegetable oil tank 1 can take place through the second restrictor 14 and the return line 16.

In this state, the sensor unit 18 measures a flow that corresponds to the set quantity of diesel fuel. Therefore, the microprocessor 22 accesses the values stored in the second data memory 24 to set the start of injection.

As soon as a higher power output is demanded from the internal combustion engine, the fuel pump 7 pumps a greater fuel volume. However, since a constant volume is pumped by the diesel fuel pump 3, an underpressure arises in the system ahead of the fuel pump 7. This causes vegetable oil to be drawn from the vegetable oil tank 1 and mixed with the diesel fuel at the fuel combiner 6. This fuel mixture is supplied to the high-pressure pump 11 through the filter 9, and from there is delivered to the injection system 12 at high pressure.

The more the power output is increased, the greater the fuel volume pumped by the fuel pump 7 becomes. Since the volume of diesel fuel always remains constant, the content of vegetable oil consequently increases with power output. As a result, the mixing ratio between diesel fuel and vegetable oil is matched to the required power output fully automatically.

When the sensor unit 18 measures a vegetable oil content of greater than 80% in the upper load range, the microprocessor 22 in the electronic controller 17 switches over. Now, the values stored in the first data memory 23 are used to control the start of injection rather than those in the second data memory 24.

In the high-load range the internal combustion engine can be operated with pure vegetable oil. By means of the electronic controller 17, the first solenoid valve 5 is now closed. At the same time, the diesel fuel pump 3 is stopped. This can take place either through the electronic controller 17, or else a pressure switch that switches the diesel fuel pump 3 off at a preset pressure is installed between the diesel fuel pump 3 and the first solenoid valve 5.

Since the internal combustion engine is operated exclusively with vegetable oil in the high load range, the control data for the start of injection are taken from the first data memory 23 in this case. In an embodiment in which the switchover to pure vegetable oil takes place when the injection quantity is more than 60% of the maximum injection quantity, the sensor unit 18 can be omitted. Here, the second data memory 24 can be used for operation with constant addition of diesel, and the first data memory 23 can be used for operation with pure vegetable oil. Since the closing of the first solenoid valve 5 and the stopping of the diesel fuel pump 3 are initiated by the controller 17, the switchover to the first data memory 23 can take place at the same time by means of the controller 17 without querying the sensor unit 18.

The pressure relief valve 10 is provided to ensure that approximately the same intake pressure is always present at the high-pressure pump 11. When the intake pressure is too high, the second pressure relief valve 10 opens, so that the excess pumped fuel is returned to the intake side of the fuel pump 7 through the return 15. The first pressure relief valve 8 functions in a similar manner. This is intended to prevent a pressure from building up ahead of the filter 9 that could destroy the filter. Here, too, the excess fuel is returned through the first pressure relief valve 8 and the return 15 to the suction side of the fuel pump 7.

Especially in the high load range, the fuel in the circuit through the fuel pump 7, the filter 9, the high-pressure pump 11, the injection system 12 and the return 15 would experience excessive heating, so that bubble formation could take place in the fuel. Therefore, the controller 17 opens the second solenoid valve 13 in the high load range. By this means, a cooling circuit for the fuel is formed through the vegetable oil tank 1. This cooling circuit is regulated by the second restrictor 14. If cold, viscous vegetable oil is present at the second restrictor 14, only a small quantity passes through the restrictor 14. As a result, a higher pressure is present at the high-pressure pump 11, ensuring complete filling of the high-pressure pump 11. Excess vegetable oil is passed through the return 15 in a small circuit and thus heats up relatively rapidly. As soon as the vegetable oil is heated, the flow rate through the second restrictor 14 increases as a result of the reduced viscosity, so that more vegetable oil passes through the return line 16 and the vegetable oil tank 1 via the cooling circuit.

Since the second solenoid valve 13 is opened only in the high load range, it is ensured that only pure vegetable oil is returned to the vegetable oil tank 1. When the internal combustion engine is operated in a medium load range again thereafter, the second solenoid valve 13 is closed once again by the electronic controller 17. At the same time, the first solenoid valve 5 is reopened, so that a constant quantity of diesel fuel can be delivered again.

Regulation of the fuel composition between the medium and lower load ranges is automatic. When the power output drops into the lower load range, the delivery volume of the fuel pump 7 is also decreased. The quantity of vegetable oil drawn from the vegetable oil tank 1 also decreases as a result. When idle speed is reached, the quantity of diesel fuel pumped from the diesel fuel tank 2 is once again sufficient for operation. Since the diesel fuel is present at the fuel pump 7 with slight overpressure in this operating state, a check valve can be placed in the line between the vegetable oil tank 1 and the fuel combiner 6. This check valve, not shown in the drawing, prevents diesel fuel from entering the vegetable oil tank 1. In contrast, if the quantity of diesel fuel delivered by the diesel fuel pump 3 and the first restrictor 4 is set such that it is not fully adequate for operating the internal combustion engine at idle speed, an underpressure is also generated by the fuel pump 7 in this load range. Vegetable oil is then drawn from the vegetable oil tank 1 in every operating state, and no diesel fuel can enter the vegetable oil tank 1 even when a check valve is not provided.

The start of injection is plotted over engine speed in the diagram in FIG. 2. The diagram is normalized to the start of injection for diesel fuel E_{D} 20, so that this plot can be represented as a straight line. This means that the actual start of injection E minus the start of injection for diesel fuel E_{D} is drawn on the Y-axis. This diagram shows very clearly how the start of injection for vegetable oil E_{P} 19 is displaced relative to the start of injection for diesel fuel E_{D} 20 as a function of speed. In the lower speed range up to approximately 2000 rpm, the start of injection for vegetable oil E_{P} 19 is approximately 3° before the start of injection for diesel fuel E_{D} 20. In a middle speed range between approximately 2000 and 3500 rpm, the spacing between E_{D} 20 and E_{P} 19 changes continuously. The two plots cross between 2500 and 3000 rpm. At this speed there is no difference between the start of injection for diesel fuel E_{D} 20 and the start of injection for vegetable oil E_{P} 19. Above about 3500 rpm, the start of injection for vegetable oil E_{P} 19 is approximately 3° later than the start of injection for diesel fuel E_{D} 20. This delayed start of injection applies for the entire high-load range.

In the example embodiment shown in FIG. 1, the controller 17 normally requires only the appropriate control data in the high-load range for operation with vegetable oil. In the low and medium load ranges, the control data for operation with diesel fuel are accessed.

All control data for the start of injection shown in the diagram in FIG. 2 are generally used with single-tank systems. Here, fuel in every mixing ratio may be used. Since this mixing ratio is then constant in all load ranges, the values in the plots E_{P} 19 or E_{D} 20 must be accessed accordingly. Consequently, the microprocessor 22 extracts the control values for the start of injection from the first data memory 23 or the second data memory 24 as a function of the fuel used. The fuel used can either be input manually or can be measured by means of a sensor.

### LIST OF REFERENCE CHARACTERS

1 vegetable oil tank
2 diesel fuel tank
3 diesel fuel pump
4 first restrictor
5 first solenoid valve
6 fuel combiner
7 fuel pump
8 first pressure relief valve
9 fuel filter
10 second pressure relief valve
11 high-pressure valve
12 injection system
13 second solenoid valve
14 second restrictor
15 return
16 return line
17 electronic controller
18 sensor
19 start of injection for vegetable oil
20 start of injection for diesel fuel
21 engine
22 microprocessor
23 first data memory
24 second data memory

1. Diesel cycle internal combustion engine that can be operated with a fuel having a low ignition point and a fuel having a higher ignition point, with at least one fuel tank (1), with a fuel pump (7), with a high-pressure pump (11), with an injection system (12) and with an electronic controller (17) in which different control parameters for operation with the fuel having the low ignition point and for operation with the fuel having the higher ignition point are stored, characterized in that control parameters (19, 20) for the start of injection are stored in the electronic controller (17), wherein the start of injection for the fuel having the higher ignition point is retarded relative to the start of injection for the fuel having the low ignition point exclusively in the high-load range or exclusively in the medium-load and high-load ranges.

2. Diesel cycle internal combustion engine according to claim 1, characterized in that the control parameters for the injection time for the fuel having the higher ignition point and for the fuel having the lower ignition point are the same.

3. Diesel cycle internal combustion engine according to claim 1, characterized in that the start of injection for the fuel having the higher ignition point is advanced as compared to the fuel having the lower ignition point in the low-load range.

4. Diesel cycle internal combustion engine according to claim 1, characterized in that a sensor (18) is provided which detects the fuel being used, and the output signal of which triggers automatic adaptation of the control parameters to the detected fuel.

5. Diesel cycle internal combustion engine according to claim 4, characterized in that the fuel being used is detected with a thermal conductivity sensor.

6. Diesel cycle internal combustion engine according to claim 4, characterized in that the fuel being used is determined by means of its viscosity as a function of temperature.

7. Diesel cycle internal combustion engine according to claim 6, characterized in that the viscosity is determined with one pressure sensor before and one pressure sensor after a restrictor.

8. Diesel cycle internal combustion engine according to claim 4, characterized in that when a mixture of fuels is used, the control parameters are determined as a function of a threshold.

9. Diesel cycle internal combustion engine according to claim 8, characterized in that, when fuel with a low ignition point and fuel with a higher ignition point are used in alternation, the threshold is dimensioned such that the control parameters for the other respective fuel are accessed for a mixture of fuel with a low ignition point and fuel with a higher ignition point in a range between 75 to 25 and 95 to 5.

10. Diesel cycle internal combustion engine according to claim 9, characterized in that the threshold is dimensioned such that, for a mixture of 80% or less of fuel with a higher ignition point to 20% or more of fuel with a low ignition point, the control parameters for fuel with a low ignition point are accessed.

11. Diesel cycle internal combustion engine according to claim 4, characterized in that two electronic controllers (17) are provided, wherein each electronic controller is associated with one fuel type.

12. Diesel cycle internal combustion engine according to claim 4, characterized in that two data memories (23, 24) for the control parameters are provided and the electronic controller (17) accesses one of the data memories (23, 24) as a function of the fuel type used.
